(19) United States
(12) Patent Application Publication
(10) Pub. No.: US 2009/0026393 A1
(43) Pub. Date: Jan. 29, 2009

(54) Mechanism for a flow control device with buffer chamber

(76) Inventors: Ping Xie, Ashland, MA (US); Xue Li, Ashland, MA (US); Kerry Yujing Xie, Ashland, MA (US)

Correspondence Address: PING XIE, 20 OLD CONNETICUT PATH, ASHLAND, MA, 01721, US

(21) Appl. No.: 11/781,910

(22) Filed: Jul. 23, 2007

(51) Int. Cl. F16K 31/00; F16K 31/12; F16K 31/44

(52) U.S. Cl. 251/18; 251/213

(57) ABSTRACT

Described here is a mechanism for a flow control device comprising of a valve casing, a plurality of buffer chambers, an elongated stem, and an actuating mechanism. The valve casing includes an inlet flow passage, an outlet flow passage, a valve seat in between, and a barrel housing extended from the flow passage. The buffer chamber is partitioned from the barrel housing by a moveable valve member and is comprised of a first channel and a second channel. The second channel is defined as a pilot valve and functions to adjust the inside pressure of the chamber. The elongated stem comprises of a plug that couples together with a pilot valve port.

### FIELD AND BACKGROUND OF THE INVENTION

The present invention relates a new mechanism for globe valves. This mechanism contains special features such the inclusion of a buffer chamber within barrel housing. These components are crucial in providing the advantage of valve action actuation with the aid of the hydraulic force from incoming fluid in order to significantly reduce actuating force.

The use of a valve to control fluid flow rate has been seen in many industries and therefore there are many valve designs. One type of common line valve is the globe or stop valve. In the past hundred years of its history, many different types of globe control valves have been developed and are available from a variety of manufacturers. In general, these valves are comprised of an upstream side, into which a fluid from a fluid source flows, and a downstream side, from which the fluid can exit and become available for some end use such as irrigation. There are two general designs for globe valves, a straight-line or Y-pattern valve. In these designs, there are conserved elements such as an inlet passage, an outlet passage, and a control stem passage containing the moveable valve stem. This movable stem typically has a sealing structure called the disc on the inner end which moves into a sealing engagement with a portion of the valve body between the inlet and outlet ports to stop fluid flow. Alternatively, it also rises to fully open or partially open positions to initiate or control flow.

A long history and wide application of these valves have demonstrated the disadvantages of current valve technology. One major concern is the actuating force needed to operate current valves. In both modes of turning on and shutting off, the movable stem of current valve systems must overcome the pressure force from the fluid entering from the inlet in order to make adjustments to the flow rate and to hold the flow rate stable at certain position. For small fluid control valves the pressure force needed to be overcome is small and therefore the valves are easily actuated by a variety of powering methods such as hand, foot, machine, solenoid or pilot air. In the case of larger valves with diameters of 8″ or more, the pressure force makes the valves much more difficult to operate, particularly when the fluid entering the valve is already at a high pressure. The man or mechanical power required for actuating a valve is proportional to the diameter of the inlet port of the valve. Therefore it is difficult to adjust the valve position or prevent fluid leakage in a valve with a large port diameter due to significant power needed to perform such operations. It is difficult to control a large valve in a precise and energy saving manner.

To overcome the issue of the large amount of actuating force needed to operate the valve port with a large diameter, the development of a new mechanism which requires less actuating force while allowing for fine valve control is necessary. It is well known that fluid flow through a valve relies upon a pressure difference across the valve. Since that pressure drop is a type of force, an ideal solution to the problem of actuating force would be to use that force to aid in the operation the valve. More specifically, the force from the fluid being transported can be utilized to drive the movement of the valve plate toward either the open or closed positions, which forms a hydraulically operated valve.

Currently, a typical hydraulically operated valve is a diaphragm valve. It is operated by directing hydraulic pressure into and out of a chamber on the upper side of the diaphragm. For example, when the valve is to be opened, pressure in the upper chamber is reduced and the fluid being handled pushes open the diaphragm for the resumption of flow. There are many limitations and cost considerations for this design. For example, when a diaphragm fails, the total cost for a replacement goes far beyond just the cost of the failed diaphragm. Also, when failures such as leakage occur, the replacement procedure requires a technician be sent to the site and the entire flow may need to be shut down during replacement of the failed component.

Clearly, it is highly desirable to have a valve, which has a simple structure and a mechanism that utilizes the pressure drop to aid in driving the opening and closing of the valve. Not only should this mechanism be efficiently applied to large diameter valves, it should also be robust, allowing it to be operated for the largest possible number of cycles and the longest possible time period, withstanding various fluids and working conditions and having an initial and replacement cost which falls into a rational range.

### SUMMARY OF THE INVENTION

The present invention demonstrates a mechanism for control valves which utilizes the hydraulic power of fluid. A valve with this mechanism would have a buffer chamber structure located within the barrel housing of the valve. The inclusion of a buffer chamber provides the advantage of actuating the movement of the valve member with less actuating force than conventional globe valves.

According to the teachings of the present invention that is provided, a mechanism for a control valve comprising of:
(a) a valve casing with an inlet port, an outlet port, a valve seat formed therebetween, and a cylindrical barrel housing extending from the valve body;
(b) a buffer chamber that is at least partially segregated from the barrel housing by a displaceable valve member that is deployed by hydraulically force from incoming fluid, so as to be moved between a closed position, in which a sealing portion of the valve member abuts the valve seat, and an open position, in which the sealing portion of the valve member is separated from the valve seat;
(c) a stem with a plug section which forms a pilot valve with the valve member and stalk section axially extended for connecting with the actuating mechanism with one end and flexible sealing means at middle thereof; and
(d) an actuating mechanism which functions for engaging to adjust the gap of the pilot valve of the buffer chamber, comprises of mechanical assemblies coupled with the plug and a plurality of actuating power, and is mounted on the valve casing.

According to further teaching of the present invention, there is, more particularly, a buffer chamber located within and partitioned from the barrel housing. This buffer chamber is enveloped by at least a moveable portion, such as the valve member and non-moveable portion, which for example could be the barrel housing. The buffer chamber comprises of a first channel or conduit that provides a communication pathway of fluid from the inlet to the buffer chamber, and a second channel which defines a controllable communication pathway of fluid from the buffer chamber into the outlet passage through the pilot valve.

According to further teaching of the present invention, the valve member forms the buffer chamber by a first preferred manner: a piston-cylinder mode, which creates the first channel by way of an annular gap between walls of the piston and cylinder.

According to further teaching of the present invention, the valve member further forms the buffer chamber by a second preferred manner: an elastic linkage mode. The elastic linkage envelopes the buffer chamber by linking the valve member and wall of the barrel housing together. A fine conduit that connects the buffer chamber and the inlet passage that creates the first channel.

According to further teaching of the present invention, the buffer chamber is configured to contain a variable amount of volume due to displacement of its moveable bottom, the valve member. This valve member moves in response to an imbalance of pressure difference on its upper and underneath faces, and is driven by the adjustment of the amount of fluid flowed from the buffer chamber into the outlet.

According to further teaching of the present invention, the pilot valve forms a controllable pathway in the buffer chamber. It comprises of a plurality of pilot valve ports positioned at the center of the planar portion thereof and an adjustable pilot plug. The displacement of the pilot plug around the pilot valve port varies the pressure balance between top face and underneath face of the valve member. This drives the movement of the valve member into a position which allows for controlled fluid flow in the pathway.

### BRIEF DESCRIPTION OF THE DRAWINGS

The invention is herein described, by way of example only, with reference to the accompanying drawings, wherein:

FIG. 1 is an exploded perspective view of a first preferred embodiment of a control valve constructed and operative according to the teachings of the present invention;

FIG. 2 is an exploded perspective view of a second preferred embodiment of a control valve constructed and operative according to the teachings of the present invention;

FIG. 3 is an exploded perspective view of a third preferred embodiment of a control valve constructed and operative according to the teachings of the present invention;

FIG. 4 is an exploded perspective view of a fourth preferred embodiment of a control valve constructed and operative according to the teachings of the present invention;

FIG. 5 is an exploded perspective view of a prior art valve.

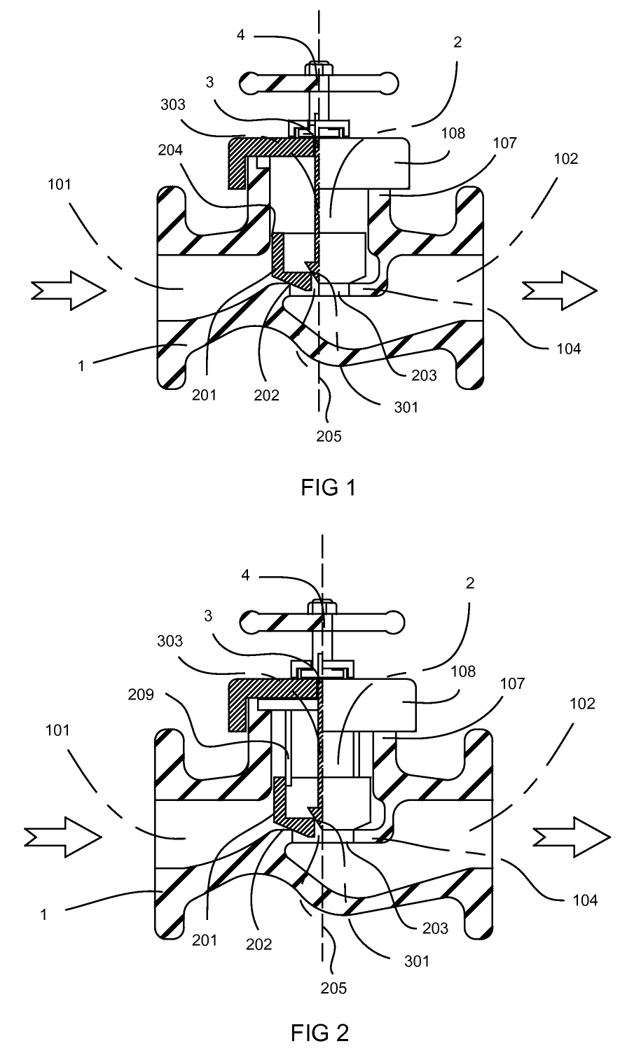

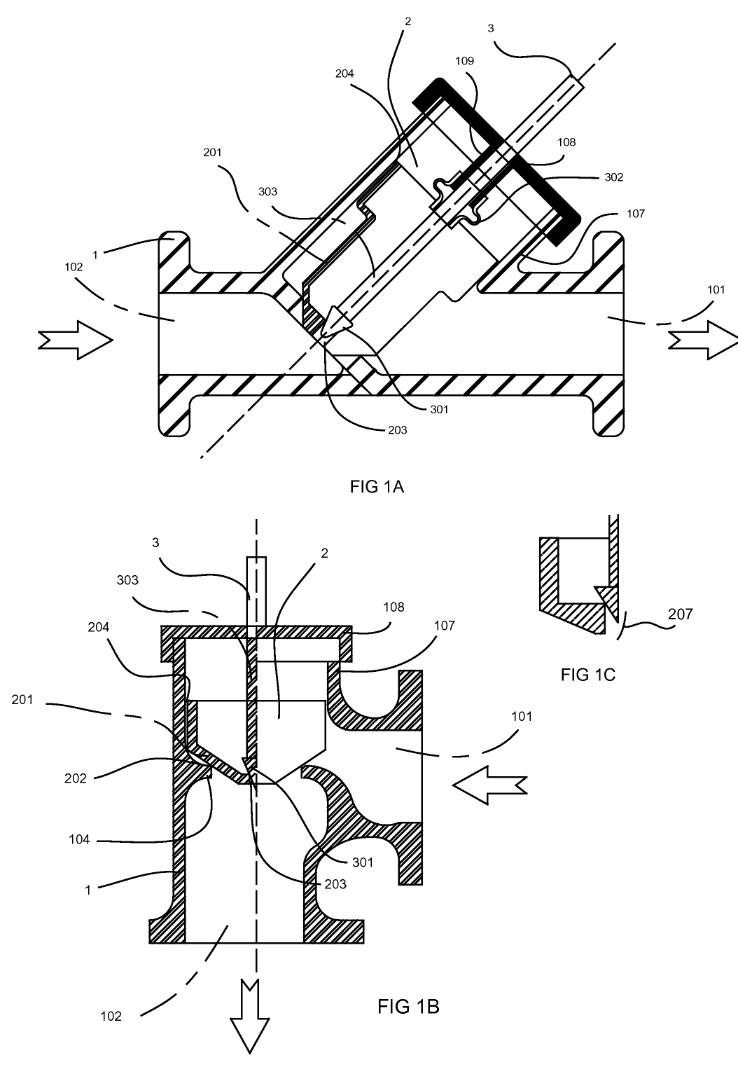

FIG. 1A is an exploded perspective view of the first preferred embodiment, shown in a Y-valve.

FIG. 1B is an exploded perspective view of the first preferred embodiment, shown in a right angle valve.

FIG 1C is a close up view of the pilot valve.

### DESCRIPTION OF INVENTION

Many of the features and components utilized in this invention are widely known and used in the field of the invention described, their exact nature or type is not necessary for an understanding and use of the invention by a person skilled in the art or science, and they will not therefore be discussed in significant detail. Furthermore, the various components shown or described herein for any specific application of this invention can be varied or altered as anticipated by this invention and the practice of a specific application of any element may already be widely known or used in the art or by persons skilled in the art or science and each will not therefore be discussed in significant detail.

A mechanism for a control valve in accordance with the teachings of the present invention illustrated in figures could be:

In general, the control valve comprises of four main components, a valve casing 1, a buffer chamber 2, an elongated stem 3 and an actuating mechanism 4.

The valve casing in this mechanism is configured in a similar fashion as in a typical globe valve with respect to its structural concerns, which includes an inlet flow passage 101 and an outlet flow passage 102. The flow passage of this mechanism has been curved due to a partition of a valve seat 104 arranged between the flow passages 101 and 102. The valve seat 104 has a sealing contour on its upper edge and defines a seat axis that is arranged a plurality of angles to an axis of the outlet. The angle could be selected from the group consisting selections from 90, 135 and 180 degrees, respectively. The valve seat 104 is arranged a certain angle to an axis of the inlet. This angle could be selected from the group consisting selections from 45 and 90 degrees, respectively. The barrel housing 107 defines a valve chamber and is coaxially, upwardly extended from the flow passage 101 of the casing with respect to the seat axis. It is located above the valve seat 104 and between the inlet flow passage 101 and the outlet flow passage 102. More specifically, the valve chamber in this invention is always located on the upstream side of the valve, instead on the downstream side as in the case of a conventional globe valve.

The lid body 108 is the top cover of the barrel housing 107. It is located at the top of the casing and tightly fastens to the upper end of the barrel housing. The lid body 108 also has a plurality of means for supporting a stem plug 301 and flexible seal members 302 thereof as well as an actuating mechanism 4. For example, there is a support tube 109 mounted on center of the lid body which allows the elongated stem 3 to insert through.

A buffer chamber 2 is coaxially positioned above the valve seat 104 and within the barrel housing 107, and is partitioned from the barrel housing 107 by at least a plurality of moveable valve members 201. The buffer chamber 2 is configured to hold a variable amount of volume due to the displacement of its moveable bottom, the valve member 201. The valve member's movement is due to an imbalance of hydraulic force applied between the upper and underneath faces thereof.

The valve member 201, which is a key member in this design, is a moveable portion of the buffer chamber 2 which is driven by the hydraulic power of fluid acting on its faces. In terms of its structure, the valve member 201 has a sealing contour 202 on underneath face of the planar portion thereof, that is shaped and sized to fit into the profile of the valve seat 104, and a pilot valve port 203 that is coaxially positioned at center of the planar portion of the valve member.

The configuration of the valve member 201 may be selected from a group including: a cup-piston, disk-piston or disk-like plate, depending respectively on the manner in which the buffer chamber 2 is formed. The valve member 201 is coaxially positioned above the valve seat 104 with respect to its axis. More specifically, it has functions of sliding toward or away from the valve seat within the barrel housing 107 in response to a change in the hydraulic pressure acting on its upper and underneath face. This in turn allows for the controlling or stopping fluid flow through the flow passage.

The buffer chamber further comprises of at least a first channel 204 and a second channel 205, respectively. These channels 204 and 205 establish a mechanism of adjusting the inside pressure of the buffer chamber: the first channel 204 creates a free flow communication pathway from the inlet passage 101 into the inside of the buffer chamber 2. Fluid, driven by pressure difference between the two regions, flows into the buffer chamber 2. The second channel 205 is formed by a pilot valve port 203 which is coaxially positioned at the center of the planar portion of the valve member 201. The pilot valve port 203 has a sealing contour on its upper edge and is coupled with the stem plug 301 of the elongated stem 3 to form a pilot valve 207 within the buffer chamber 2. The pilot valve 207 creates a controllable communication pathway of fluid from the buffer chamber 2 into the outlet passage 102. In other words, the pressure inside the buffer chamber 2 can be adjusted by controlling the status of the pilot valve 207. The buffer chamber 2 could be partitioned from the barrel housing 107 with a manner of either a piston-cylinder mode or elastic linkage mode in order to fit into various applications.

The elongated stem 3 is coaxially inserted into the valve casing 1 through the lid body 108 and is able to be longitudinally shifted along direction of the axis of the seat toward or away from the pilot valve port 203 on the valve member 201. It comprises of a plug section 301, a stalk 303, and a flexible sealing means 302.

The stem 3 comprises a plurality of variations for the plug section 301 in terms of its setup. Specifically this refers to the shape and location of the plug 301 on the stem 3 and stalk section 303. The plug 301 has a plurality of profile shapes and sizes to fit into the sealing contour 205 of the pilot valve port on the valve member 201. The stalk section 303 is a rod extended from the plug, joined with the actuating means 4 on one end and the flexible sealing means 302 in middle portion thereof.

The flexible sealing means 302 is a flexible tubule with adjustable length which functions to keep the stem 3 moveable and to seal the stem onto the support tube 109 of either the lid body 108 or the casing to prevent fluid leakage. The tube could be made of materials such as rubber, plastic and metal.

The actuating mechanism 4 functions for engaging to adjust the position of the plug away from or toward to the pilot valve port 203 along direction of the seat axis through the stem 3. It defines mechanical assemblies that include a plurality of types of actuating power and a plurality of mechanical linkages, such as a gear box which could be located between the elongated stem 3 and the actuating power. The actuating mechanism 4 is mechanically mounted on outside of the casing. The power source for the actuating mechanism could be chosen from the group including the selections: electrical, mechanical, man power and their combinations.

More detail regarding differences between each of the preferred arrangements of the valve is demonstrated in the figures and is described below. More specifically, each arrangement concentrates on a particular setup of forming a buffer chamber in order to fit broad applications.

The buffer chamber could be further classified into or comprised of two portions: a fixed portion and a moveable portion. It could be also partitioned from the barrel housing by a manner of either a piston-cylinder mode or elastic linkage mode in order to fit into various applications.

The first preferred embodiment, shown in FIG. 1, demonstrates a buffer chamber 2 that is formed by the piston-cylinder mode. The buffer chamber 2 is enveloped by the valve member 201, which consequently may define a cup-like piston or disk-like piston, the cylindrical barrel housing 107 and the lid body 108. More specifically in FIG. 1, inner wall of the barrel housing 107, acting as the cylinder and the fixed portion, outwardly pairs with outer sidewall of the piston of the valve member 201. This pairing of the piston 208 and the cylinder forms annular gap in between, thus allowing the piston to be able to slide along the cylinder wall surface. The annular gap, defined as the first channel 204, leaves a conduit for the free flowing of fluid from the inlet into the buffer chamber 2.

The second preferred embodiment, shown in FIG. 2, demonstrates a buffer chamber 2 that is also formed by the piston-cylinder mode, but with different characteristics. More particularly, the buffer chamber 2 is enveloped by the valve member 201, which may define a cup-like piston, a guiding insert 209 and the lid body 108. The guiding insert 209 further defines a cylindrical sleeve that has a smooth outer surface on its sleeve section and an annular flange projecting from the outer surface thereof on its higher end. The guiding insert 209 may be secured on the upper edge of the barrel housing 107 and assembled near the lid body 108. More specifically, inner sidewall of the cup piston outwardly pairs with outer wall of the insert, acting as cylinder and fixed portion. The pairing of the piston 208 and the cylinder forms annular gap in between, thus allowing the piston to slide along the surface of the cylinder wall. The gap, defined as the first channel 204, leaves a conduit for the free flowing of fluid from the inlet 101 into the buffer chamber 2.

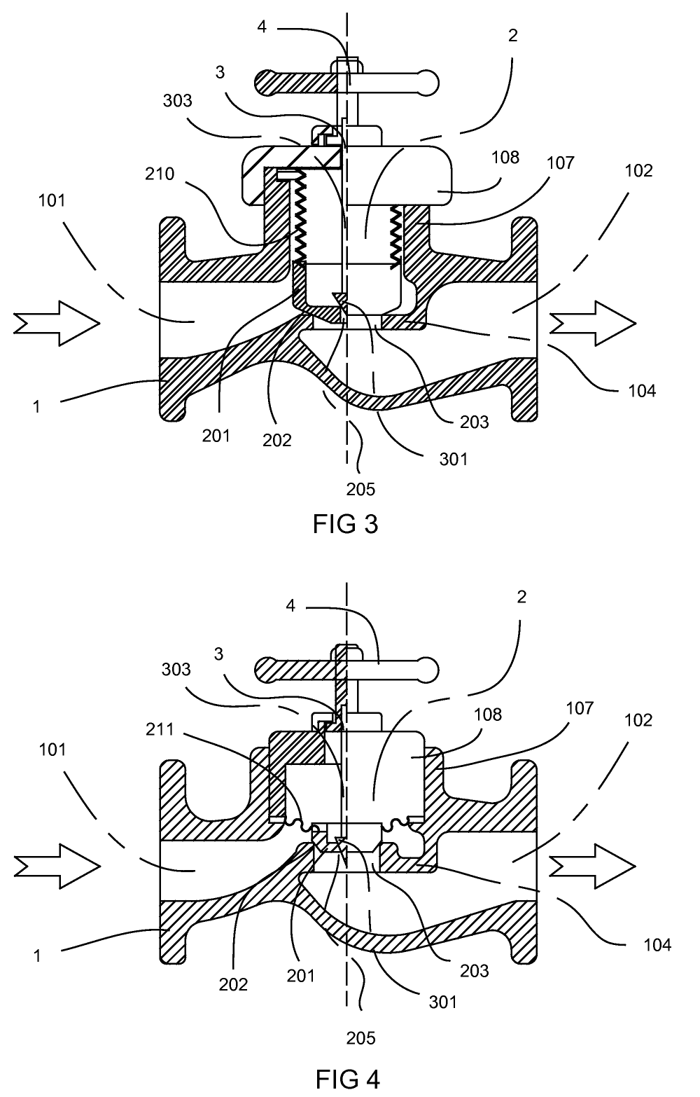

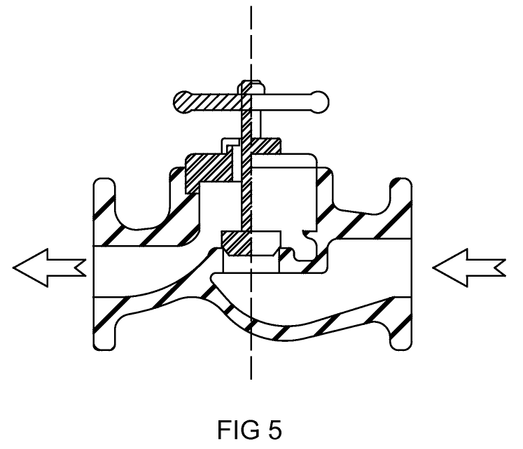

The third preferred embodiment, shown in FIG. 3, demonstrates a buffer chamber 2 that is formed by the valve member 201 in a manner of the elastic linkage mode. The valve member 201 here may define a disk-like plate with all features described previously. In one example of this embodiment, the elastic linkage defines a plurality of flexible bellows 210. The bellows 210 have at least one convolution and annular flange projecting from the outer surface on its higher end thereof. The buffer chamber 2 is isolated and sealed from the barrel housing 107 in a way such that the bellows 210 associate with the disk plate on its lower end and with the barrel housing 107 by its flange on its higher end. This allows freedom for the up or down movement of the disk plate within the barrel housing 107 when hydraulic force is applied onto it. There is a fine conduit between inside of the buffer chamber 2 and the inlet 101 that creates the linkage in between and allows for free communication of fluid in one direction from the inlet 101 into the buffer chamber 2.

The fourth preferred embodiment, shown in FIG. 4, demonstrates a buffer chamber 2 that is also formed by the valve member 201 in a manner of the elastic linkage mode, but it is different from the one described in the third preferred embodiment. In this example, the elastic linkage defines a plurality of flexible diaphragms 211. The diaphragm 211 defines a plurality of woven pads formed as a circular wafer with at least one coaxially convolution. Each diaphragm has at least one corrugated S cross sections for enhancing displacement of the plate within the barrel housing 107 and a plurality of annular flanges on its outer edge. The diaphragm 211 is tightly molded to the plate by its inner circular edge and outwardly attached and mounted on wall of the barrel housing 107, such as by its flange. The diaphragm 211 may deform equally in two directions (up or down). The disk plate is free to move up or down within the barrel housing 107 when hydraulic force is applied on the valve member 201. There is a fine conduit that creates a fluid linkage between the inlet 101 and inside of the buffer chamber 2. It allows for free communication of fluid in one direction from the inlet 101 into buffer chamber 2.

The operation of the above-described embodiments will be explained hereinafter.

The mechanism of the control fluid process contemplated by this invention is very generally defined in four operational modes, with variations thereto.

The first mode is an idle or valve close mode, in which the plug 301 is tightly seated on the pilot valve port 203 and the valve member 201 is firmly pressed on the valve seat 104 by the pressure (from the inlet) applying favorably on upper face of the valve member, forcing the valve tightly closed. The fluid in the inlet 101 is completely isolated from fluid in the outlet 102.

The second mode is an initiating open mode. Actuating mechanism activates, thereby shifting the plug 301 upward, away from the pilot valve port 203 and leaving a gap between the plug and pilot valve port. Fluid in the buffer chamber 2 releasing into the outlet 102 reduces the buffer chamber pressure significantly. This causes the valve member 201 to shift up towards the plug and leaving the valve in a slightly open position. As the gap between the valve member 201 and the plug 301 decreases, the upward movement of the valve member slows and stops when the system reaches a point where acting forces on both sides of the valve member 201 achieves equilibrium. At this point, the valve member 201 keeps a rational gap distance from the plug and steadily floats between the valve seat 104 and the plug 301, keeping the valve in a proper opened position.

The third mode is a flow controlling mode. Movement of the plug towards a desirable position (either toward or away from the pilot valve port 203) by the actuating mechanism 4 causes a corresponding movement of the valve member 201. Control of the movement and position of the valve member 201 allows regulate the flow rate of the valve.

The fourth mode is a flow closing mode. Initiated by a downward shift of the plug 301, the valve member 201 travels toward to the valve seat 104 in order to keeps a rational gap distance from the plug. As results of it, the flow rate has been reduced. Along with step by step reducing the gap between the plug 301 and the pilot valve port 203, such movements will be ended when the valve member and the plug have completely pressed onto their respective seats. This allows all pressure from the inlet fluid acting on the upper face of the valve member to tightly press it on the valve seat and completely seal the valve, therefore preventing leakage.

Thus, it is apparent that there has been provided in accordance with the invention a fluid control valve that fully satisfies the objects, aims and advantages set forth above. Various changes to the foregoing described and shown structures are now evident to those skilled in the art. The matter set forth in the foregoing description and accompanying drawings is therefore offered by way of illustration only and not as a limitation. Accordingly, the particularly disclosed scope of the invention is set forth in the above claims and descriptions, but nor limited.

We claim:

1. A mechanism for a flow control device comprising:
a valve casing including an inlet flow passage, an outlet flow passage, a valve seat therebetween having a sealing profile on the upper edge thereof and defining a seat axis that is arranged at a plurality of angles with respect to an axis of said outlet flow passage, a barrel housing which is upwardly and coaxially extended from the flow passage with respect to said seat axis, and a lid body assembling at the upper end of said barrel housing;
a plurality of buffer chamber coaxially positioned above said valve seat, being partitioned from said barrel housing by at least a plurality of moveable valve members and comprising of a plurality of first channels and a plurality of second channels that defines a plurality of pilot valve ports coaxially located on the center of the valve member; said valve member defining a plurality of sealing contours on the underneath face thereof that is shaped and sized to fit the profile of said valve seat and is engaged for longitudinal traveling between open and closed positions of the valve, driven by the hydraulic force of the incoming flow of fluid;
an elongated stem comprising of a plurality of plug sections that are shaped and sized to fit into the profile of said pilot valve port that together forms a plurality of pilot valves within the buffer chamber, thereby creating a controllable flow pathway from said buffer chamber into the outlet passage, and a stalk section axially extended from said plug for connecting with and being driven by an actuating mechanism at one end thereof and joined with flexible sealing means at middle thereof; and
said actuating mechanism with the means for adjusting the gap between said plug and said pilot valve port, comprising of mechanical assemblies connected with the stalk at one end thereof and a plurality of actuating powers at the other end thereof, and mounted on the outside of the valve casing; an actuating power is chosen from the group comprising of the selections: automatic power, man power and their combinations.

2. The valve recited in claim 1, wherein the angle of the seat axis with respect to the axis of the outlet is selected from the group comprising of the selections: 90, 135 and 180 degrees.

3. The valve recited in claim 1, wherein the buffer chamber is enveloped in a manner such that the outer perimeter wall of the valve member pairs and slides with each other along inner sidewall of the barrel housing and is further assembled with the lid body, and wherein the first channel defines an annular gap between the perimeter walls of said barrel housing and said valve member to create a free flow pathway from the inlet passage into said buffer chamber.

4. The valve recited in claim 1, wherein the buffer chamber is enveloped in a manner such that the inner perimeter wall of the valve member pairs with and slides against each other along the outer perimeter wall of a guiding insert and is further assembled with the lid body, said guiding insert defines a cylindrical sleeve with a flange projecting from the outer surface on upper end thereof and is coaxially secured on the upper edge of the barrel housing, and wherein the first channel defines an annular gap between perimeter walls of said guiding insert and said valve member to create a free flow pathway from the inlet passage into said buffer chamber.

5. The valve recited in claim 1, wherein the buffer chamber is formed by a plurality of flexible tubes with adjustable length substantially associated with the valve member at one end and the barrel housing and the lid body at the other end, said flexible tube further defines a plurality of flexible bellows that comprises of at least one convolution and a flange projecting from outer surface on the upper end thereof and is secured on upper edge of said barrel housing, and wherein the first channel defines a fine conduit that links the inlet passage and said buffer chamber and creates a free flow pathway from said inlet passage into said buffer chamber.

6. The valve recited in claim 1, wherein the buffer chamber is formed in a manner such that a plurality of flexible diaphragms is integrally molded to the valve member by the inner circular edge thereof and further substantially attached to and sealed with the barrel housing by outer periphery edge thereof, the flexible diaphragm substantially defined as a plurality of woven pads formed as a circular wafer with coaxially corrugated S cross sections, and wherein the first channel defines a fine conduit that links the inlet and said buffer chamber and creates a free communication pathway for flowing from said inlet into said buffer chamber.

7. A mechanism for a flow control valve comprising:
a valve casing including an inlet flow passage, an outlet flow passage, a valve seat therebetween with a sealing profile on the upper edge thereof and defining a seat axis that is arranged at a plurality of angles with respect to an axis of said outlet flow passage, a barrel housing that is upwardly and coaxially extended from the flow passage with respect to said seat axis, and a lid body which assembles with said barrel housing;
a valve member engaging for longitudinal traveling between the open and closed positions of the valve driven by the hydraulic force of the incoming fluid, defining a plurality of sealing contours on underneath face thereof that is shaped and sized to fit into the profile of said valve seat, and at least partially segregating a portion of said barrel housing to form a buffer chamber, which comprises of a plurality of first channels and a plurality of second channels which together configures a plurality of pilot valve ports positioned on the center of said valve member;
an elongated stem engaging for longitudinal shifting along the direction of said seat axis and comprising of a plurality of plug sections with a sealing contour shaped and sized to fit into a profile of the pilot valve port which together assembles a pilot valve for a controllable and adjustable flow communication pathway from said buffer chamber into said outlet passage, and a plurality of stalk sections longitudinally extended from the plug for associating with an actuating mechanism at one end on the outside of the casing and joined with a plurality of flexible sealing means at middle thereof.

8. The control valve recited in claim 7, wherein the valve member is configured as a plurality of pistons, wherein the buffer chamber is enveloped, in a manner where the perimeter sidewall of said piston is coupled with and slides against the perimeter sidewall of a cylinder, and wherein the first channel defines an annular gap between perimeter walls of said piston and said cylinder to create a free fluid communication pathway from the inlet passage into said buffer chamber.

9. The control valve recited in claim 8, wherein the annular gap is configured to be selected from the group comprising of selections:
a) inner cylindrical sidewall of the barrel housing is coupled with the outer perimeter sidewall of the piston and
b) outer perimeter sidewall of a guiding insert is coupled with inner perimeter sidewall of said piston, said guiding insert is further defined as a cylindrical sleeve with a flange projecting from the outer surface on the higher end thereof and is coaxially secured on the upper edge of said barrel housing by the lid body.

10. The control valve recited in claim 7, wherein the valve member is configured as a plurality of disk-like plates, wherein the buffer chamber is sealed and segregated in a manner such that the plate is coupled with the barrel housing through a plurality of flexible means, and wherein the first channel defines a plurality of fine conduits that links the inlet passage and said buffer chamber to create a free flow communication pathway from said inlet passage into said buffer chamber.

11. The control valve recited in claim 10, wherein the flexible means is configured as a plurality of bellows sealed together with a plate on the lower end thereof, said bellows further comprising of at least one convolution and a flange projecting from the outer surface thereof on higher end thereby and secured on upper edge of the barrel housing by the lid body.

12. The control valve recited in claim 10, wherein the flexible means is configured as a plurality of flexible and annular diaphragms assembled with a plate on the inner circular edge thereof and with the barrel housing on outer edge thereof, the diaphragm further substantially having a coaxial, “S” shaped cross section for enhancing wide displacement of the plate and an annular flange on the outer edge thereof for being secured on upper edge of said barrel housing by the lid body.

13. A mechanism of a flow control device comprising:
a valve body including an inlet flow passage, an outlet flow passage, a valve seat therebetween, a barrel housing above the valve seat, and a lid body assembled with the barrel housing;
a valve member comprising of a plurality of sealing contours on underneath face thereof, shaped and sized to fit into the profile of said valve seat and a plurality of pilot valve ports positioned at the center thereof, engaging for longitudinally traveling between open and close positions of the valve with aid of hydraulic force from the incoming flow, and at least partially segregating said barrel housing to form a buffer chamber.
an elongated stem comprising of a plurality of plug sections shaped and sized to fit into a profile of the pilot valve port to form a plurality of pilot valves of said buffer chamber, and a stalk section axially extended from the plug for connecting with and being driven by an actuating mechanism at one end and joining with a plurality of flexible sealing means at the middle thereof; and engaging for longitudinally traveling along axis of said valve seat for adjusting the gap between said plug and said pilot valve port.

14. The control valve recited in claim 13, wherein the buffer chamber comprises of a plurality of first channels for free flow communication pathway from said inlet into said buffer chamber and a plurality of second channels for an adjustable flow communication pathway from said buffer chamber into said outlet, said first channel further defining a plurality of openings between said buffer chamber and the inlet, and said second channel defining said pilot valve that creates a controllable flow pathway from said buffer chamber into said outlet.
